(19) United States
(12) Patent Application Publication
(10) Pub. No.: US 2012/0048431 A1
(43) Pub. Date: Mar. 1, 2012

(54) RARE-EARTH PERMANENT MAGNET AND PRODUCTION PROCESS FOR THE SAME

(75) Inventors: Yoshiyuki Nakazawa, Saitama (JP); Ryutaro Kato, Saitama (JP); Haruhiko Shimizu, Saitama (JP)

(73) Assignee: HONDA MOTOR CO., LTD., Tokyo (JP)

(21) Appl. No.: 13/257,052

(22) PCT Filed: Mar. 5, 2010
(86) PCT No.: PCT/JP2010/054162

§ 371 Date: Nov. 3, 2011

(30) Foreign Application Priority Data
Mar. 19, 2009 (JP) 2009-068418

(51) Int. Cl. C21D 6/00; H01F 1/153; C21D 8/00; H01F 1/053

(52) U.S. Cl. 148/557; 148/302

(57) ABSTRACT

HfC particles having an average particle size of 5 to 100 nm are dispersed in an R—Fe—B type alloy in an amount of 0.2 to 3.0 atom %. Crystal grains are refined avoiding decreasing an amount of magnet components by containing carbide and coercive force can be improved, avoiding degradation of saturated magnetization by refining the crystal grains.

### BACKGROUND OF THE INVENTION

1. Field of the Invention

The present invention relates to a rare-earth permanent magnet and to a production process for the same, and in particular, relates to a technique in which coercive force can be increased by refining a crystal grain.

2. Related Art

As a production method for a permanent magnet made of Nd—Fe—B type alloy, a powder metallurgy method in which a single-crystal alloy powder loaded in a die is processed by magnetic field orientation and is compacted and sintered is known. However, in the powder metallurgy method, when a raw powder is refined, a specific surface area thereof is increased, so that a complicated treatment is required to avoid oxidation. As a result, the powder metallurgy method has limitations in increasing coercive force of a sintered magnet by refining crystal grains thereof.

As a production method other than the powder metallurgy method, there have been a known method in which an alloy powder obtained by rapidly cooling a molten metal is heat-treated and is solidified by compacting with resin and an isotropic bond magnet is obtained. Furthermore, there have been known methods in which an alloy powder obtained by rapidly cooling a molten metal is processed as a hot compressing compact by a hot press and an isotropic bulk magnet is obtained. For example, Japanese Patent Application, First Publication No. 60-100402 discloses a method in which an anisotropic bulk magnet is obtained by hot processing an isotropic bulk magnet.

### SUMMARY OF INVENTION

In an Nd—Fe—B type alloy permanent magnet that is produced using the alloy powder obtained by rapidly cooling a molten metal, it has been known that fine crystal grain is closely related to developing coercive force. It has been found that the crystal grain grows in processing such as hot plastic working, thereby decreasing coercive force. In the past, as described in Japanese Patent Application, First Publication No. 63-196014, a technique in which a transition metal such as Ti, Zr, or Hf is added as a simple metal is proposed. Furthermore, as described in Japanese Patent Application, First Publication No. 2-4941, a technique in which the grain coarsening is inhibited and a composition thereof is made uniform by an addition of a boride such as HfB₂ is proposed. However a technique for refining the grains by an addition of carbide has not yet been reported. As a main reason for this, addition of carbide causes decrease of magnetic components and degradation of saturated magnetization since Nd₂Fe₁₄C and Nd₂C₃ are formed and elements of Nd₂Fe₁₄B as a main phase is displaced with C (carbon).

Therefore, an object of the present invention is to provide a rare-earth permanent magnet and a production process for the same, in which crystal grains can be refined, avoiding decrease of magnetic components by containing carbide, and a coercive force can be increased, avoiding degradation of saturated magnetization by refining the grains.

The present inventors have studied compounds in which growth of the crystal grain can be inhibited by a pinning effect. As a result of the studying of each compound composed of Nb, Mo, Cr or Hf, and B, C, or Si, HfC in which energy for production reaction of carbide is low was focused on. Production energy of HfC is low, so that experiments were repeated based on estimating that probabilities of forming Nd₂Fe₁₄C and Nd₂C₃, and displacement of elements of Nd₂Fe₁₄B as a main phase with C may be low. As a result, the present inventors have found that, when HfC particles having a predetermined size are contained within a certain range, not only can growth of the crystal grains by heating be inhibited, but also formation of a compound combined with Nd₂Fe₁₄B as a main phase can be avoided.

The rare-earth permanent magnet of the present invention was made based on this knowledge, and the present invention provides a rare-earth permanent magnet in which HfC particles having an average particle size of 5 to 100 nm are dispersed in a R—Fe—B type alloy (R is a rare-metal element) at amount of 0.2 to 3.0 atom %.

The present invention provides a production process for the rare-earth permanent magnet: including rapidly cooling a molten metal made of R—Fe—B type alloy (R: rare-earth element) containing HfC particles having an average particle size of 5 to 100 nm in an amount of 0.2 to 3.0 atom %, thereby obtaining a magnet material which is amorphous or contains crystal grains having an average particle size of 5 μm or less; and providing magnetic anisotropy to the magnet material by hot plastic working.

A reason for the numeral limitation in the present invention is explained together with functions thereof hereinafter. Reference symbol “%” in the following explanation means “atom %”.

### HfC: 0.2 to 3.0%

When amount of HfC is less than 0.2%, the pinning effect is not sufficient, so that the crystal grain easily grow in heating. On the other hand, when the amount of HfC is more than 3.0%, the amount of the main phase as a magnetic component is decreased and saturated magnetization is degraded. Therefore, the amount of HfC is 0.2 to 3.0%. The amount of HfC is preferably 0.6% or more.

### Average Particle Size of HfC: 5 to 100 nm

When the average particle size of HfC is less than 5 nm, HfC is too small compared to the crystal grain of the main phase, so that the pinning effect is not sufficient. As a result, the crystal grains easily grow by heating. On the other hand, when the average particle size of HfC is greater than 100 nm, dispersion of the HfC is not sufficient, so that the pinning effect is not sufficient. Therefore, the average particle size of the HfC is 5 to 100 nm.

In the production process of the present invention, a magnet material that is amorphous or has an average particle size of 5 μm or less is obtained by rapidly cooling a molten metal. In the magnet material, HfC particles are precipitated and dispersed in a crystal grain boundary of the main phase. As a means for rapidly cooling the molten metal, for example, a molten metal extraction method can be applied. In the molten metal extraction method, a molten metal composed of a R—Fe—B type alloy is supplied through a nozzle to a surface of a roll provided with a water-cooling jacket in an inside thereof while rotating the roll and is rapidly cooled and solidified. In the molten metal extraction method, molten metal supplied to the roll is instantly cooled and solidified, so that a thin strip that is amorphous or contains fine crystal grains can be obtained. The width of the thin strip obtained by this method is 0.1 to 10 mm and the thickness thereof is 1 to 100 μm.

Next, a magnet material is provided with magnetic anisotropy by hot plastic working. In the condition of the magnet material, directions of magnetization of easy axes of the crystal grains of the main phase are different from each other and are aligned along a direction in which the magnet material is deformed by hot plastic working. Therefore, the magnet material obtained by hot plastic working is magnetized toward the pressure direction, so that a permanent magnet of which the magnetic line is aligned along the pressure direction can be obtained. In this case, HfC particles are dispersed in crystal grain boundaries of the main phase of the magnet material, so that growth of the crystal grain by heating can be inhibited.

When the magnet material is a thin strip, preferably, the material is crushed into a powder before hot plastic working, and the powder is subjected to hot compacting. In this case, as a method for the compacting, powder injection compacting (hot isostatic pressing treatment) in which the powder is pressed under heating from all directions with a substantially equal strength, and hot pressing in which the powder is subjected to compression compacting in a cavity of a die can be used. By this processing, hot plastic working can be easily performed. An amorphous structure is crystallized by hot compacting. The magnetization easy axes of the crystal grains can be substantially aligned along the compression direction by hot pressing. By this processing, the degree of orientation of the magnetization easy axis can be upgraded by following hot plastic working, so that a high density of a magnetic flux can be obtained after magnetization.

The preferable temperature of hot plastic working is 800° C. or less, and more preferably 750° C. or less. Furthermore, the most preferable temperature is 700° C. or less. The crystal grains of the magnet material can be further refined as the temperature of hot plastic working is low. However, when the temperature is too low, cracking and breaking occur in the magnet material in hot plastic working, so that the temperature is preferably set at 600° C. or more.

As a rare-earth element, although Nd is commonly used, other elements such as Dy (dysprosium) and Tb (terbium) can also be used. A percentage of each element can be set as follows. For example, R is 5 to 20%, Fe is 65 to 85%, B is 3 to 10%, and HfC is 0.2 to 3.0%.

A method for rapidly cooling a molten metal is not limited by molten metal extraction process but can be applied to various methods. For example, a billet substantially the same as the thin strip obtained by the molten metal extraction process can be obtained by increasing cooling rate in a mold in continuous casting. Furthermore, a powder magnet material can be obtained by atomizing processing.

The crystal grains of the main phase are deformed by hot plastic working, so that the crystal grain boundary is disordered, and coercive force is deceased. Therefore, the crystal grain boundary is preferably smoothed by heat treatment after hot plastic working. In this case, the temperature of the heat treatment is preferably 600 to 900° C.

In the rare-earth permanent magnet obtain by the explained processes, HfC particles having an average particle size of 5 to 100 nm are dispersed in a R—Fe—B type alloy (R is rare-earth element) in an amount of 0.2 to 3.0 atom %. Production energy of HfC is low, so that the condition of the rare-earth permanent magnet is stable. Therefore, decrease of magnetic components by combining and displacing C with other components can be inhibited. Furthermore, the crystal grains can be made to remain in a fine size by pinning effects of the HfC particles, so that coercive force can be improved, avoiding degradation of saturated magnetization. In such a rare-earth permanent magnet, the average grain size of the structure is preferably 10 to 500 nm and the average particle size of the HfC particles is preferably 5 to 20 nm.

According to the present invention, crystal grains can be refined avoiding decreasing amount of magnet components by containing carbides and coercive force can be improved avoiding degradation of saturated magnetization by refining the crystal grain.

### BRIEF DESCRIPTION OF DRAWINGS

FIG. 1 is a graph showing relationships between additive amounts of HfC, Hf, and C, and coercive forces, in an example of the present invention.

FIG. 2 is a graph showing relationships between average crystal particle sizes and coercive forces of a rare-earth permanent magnet in the example of the present invention.

FIGS. 3A and 3B are photographs taken by a transmission electron microscope showing partial portions of a rare-earth permanent magnet in the example of the present invention, in which FIG. 3A is a photograph of a case in which HfC is not added to the rare-earth permanent magnet and FIG. 3B is a photograph of a case in which HfC is added thereto.

### DESCRIPTION OF PREFERRED EMBODIMENTS

An alloy consisting of Nd_{13·2}Fe_{(80. 9-x)}B_{5·9}Mₓ was molten and the melted metal was supplied to a surface of a roll from a nozzle. In this case, reference symbol M was one of Hf, C or HfC and reference symbol ₓ was variously set within 0 to 0.8. The roll was cooled by a water-cooling jacket included therein and a rotating speed (circumferential velocity) thereof was set at 17.5 mm/s. The alloy solidified by cooling on the roll is removed therefrom and a sample of a thin strip having a thickness of about 25 μm was produced. As a result of observation by an electron microscope, the sample just after rapid cooling was found to have a mixed structure of a crystal phase and an amorphous phase and the grain size of the crystal phase was 100 nm or less.

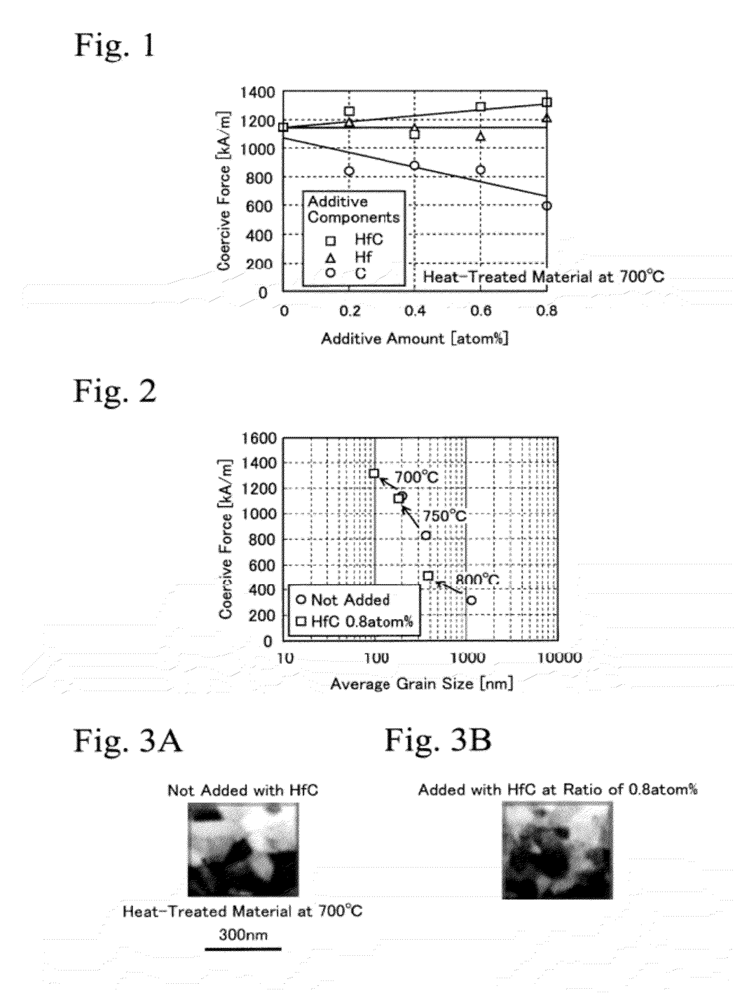

Each obtained thin strip sample was heat-treated at a holding temperature of 700° C., 750° C., and 800° C. for ten minutes, so that the amorphous phase was crystallized so as to avoid effects on magnetic characteristics, and the growing degrees of the crystal grains were observed. Magnetization measurement was performed with respect to each sample using a sample vibrating type magnetometer. Relationships between an additive amount of each element and coercive force are shown in FIG. 1. Structures of the samples were observed using an electron microscope. Relationships between average grain sizes and coercive forces calculated by observing the structures are shown in FIG. 2. Furthermore, photographs showing the structures taken by a transmission electron microscope (TEM) are shown in FIGS. 3A and 3B.

FIG. 1 shows the relationships between the additive amount of each element and coercive force in the sample heat-treated at a temperature of 700° C. As shown in FIG. 1, the coercive force was increased as the additive amount of HfC was increased. On the other hand, when Hf is simply added, the coercive force was hardly varied. When C is simply added, the coercive force was decreased as the additive amount of C was increased. Therefore, it is presumed that simultaneous addition of Hf and C is effective for increasing coercive force.

FIG. 2 shows relationships between average grain sizes and coercive forces in a sample to which was added HfC and in a sample to which HfC was not added. As shown by the arrow heads in FIG. 2, when the temperatures of the heat treatments for the samples were the same, the grain size of the sample to which was HfC was small and the coercive force thereof was large compared to those of the sample to which HfC was not added. This means that the growing speed of the crystal grain was inhibited by the addition of HfC.

FIGS. 3A and 3B are photographs taken by the TEM showing structures in the sample to which was added HfC and in the sample to which HfC was not added, which were heat-treated at a temperature of 700° C. In the photographs thereof taken by the TEM, the crystal grains of the sample to which was added HfC were fine compared to those of the sample to which HfC was not added. Elemental mapping with respect to the sample added with HfC was performed. It was confirmed that fine crystal grains having grain sizes of about 10 nm and containing Hf were uniformly precipitated and dispersed. Growth of the crystal grains in the main phase were inhibited by the deposits, so that the crystal grains are refined and coercive force was improved.

In the present invention, coercive force can be improved, avoiding degradation of saturated magnetization by refining crystal grains, so that the present invention can be applied to technical fields of motors, and the like.

1. A rare-earth permanent magnet, wherein HfC particles having an average particle size of 5 to 100 nm are dispersed in a R—Fe—B type alloy (R is a rare-earth element) in an amount of 0.2 to 3.0 atom %.

2. (canceled)

3. The rare-earth permanent magnet according to claim 1, wherein the amount of HfC particles is at least 0.6 atom %.

4. A production process for a rare-earth magnet, comprising:
rapidly cooling a molten metal made of a R—Fe—B type alloy (R: rare-earth element) containing HfC particles having an average particle size of 5 to 100 nm in an amount of 0.2 to 3.0 atom %, thereby obtaining a magnet material which is amorphous or contains crystal grains having an average particle size of 5 μm or less; and
providing magnetic anisotropy to the magnet material by hot plastic working.
